(19) United States
(12) Patent Application Publication
(10) Pub. No.: US 2014/0067574 A1
(43) Pub. Date: Mar. 6, 2014

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Hidehiko Miyakoshi, Shizuoka-ken (JP)

(73) Assignee: TOSHIBA TEC KABUSHIKI KAISHA, Tokyo (JP)

(21) Appl. No.: 13/968,547

(22) Filed: Aug. 16, 2013

(30) Foreign Application Priority Data
Sep. 6, 2012 (JP) 2012-196347

(51) Int. Cl. G06Q 20/20

(52) U.S. Cl. CPC G06Q 20/208
USPC 705/23

(57) ABSTRACT

In accordance with one embodiment, an information processing apparatus includes an acquisition module configured to acquire the image captured by an image capturing module having sensitivity to visible light and near-infrared ray, a first extraction module configured to extract a first feature amount of the captured commodity from an infrared ray image representing the near-infrared ray component of the captured image, a second extraction module configured to extract a second feature amount of the captured commodity from a visible light image representing the visible light component of the captured image and a recognition module configured to recognize the commodity based on at least one of the first feature amount and the second feature amount.

### CROSS-REFERENCE TO RELATED APPLICATION

This application is based upon and claims the benefit of priority from Japanese Patent Application No. 2012-196347, filed Sep. 6, 2012, the entire contents of which are incorporated herein by reference.

### FIELD

Embodiments described herein relate to an information processing apparatus and an information processing method.

### BACKGROUND

There is a conventional technology which extracts the feature amount of an object such as color, color distribution, size and shape by capturing an image of the object and the like and compares the extracted feature amount with pre-prepared data (feature amount) for comparison to recognize the category of the object. Moreover, a system is proposed which applies the technology to recognizing a commodity such as vegetable or fruit to register the sales of the recognized commodity.

### BRIEF DESCRIPTION OF THE DRAWINGS

FIG. 1 is a perspective view illustrating external configurations of a checkout system according to a first embodiment;

FIG. 2 is a block diagram illustrating the hardware arrangement of a POS terminal and a commodity reading apparatus shown in FIG. 1;

FIG. 3 is a diagram schematically illustrating an example of the data configuration of a FLU file shown in FIG. 2;

FIG. 4 is a diagram schematically illustrating an example of the data configuration of a first commodity characteristic file shown in FIG. 2;

FIG. 5 is a diagram schematically illustrating an example of the data configuration of a second commodity characteristic file shown in FIG. 2;

FIG. 6 is a diagram illustrating an example of the spectral sensitivity characteristic of an image sensor;

FIG. 7 is a diagram illustrating an example of the transmission characteristic of an IR cut filter;

FIG. 8 is a block diagram illustrating the functional components of the POS terminal and commodity reading apparatus shown in FIG. 1;

FIG. 9 is a diagram illustrating a display example of the commodity candidate displayed on a display device of the commodity reading apparatus;

FIG. 10 is a flowchart illustrating the procedure of a commodity recognition processing executed by the commodity reading apparatus;

FIG. 11 is a flowchart illustrating the procedure of a sales registration processing executed by the POS terminal;

FIG. 12 is a perspective view illustrating configurations of a self POS according to a second embodiment; and

FIG. 13 is a block diagram illustrating the hardware arrangement of the self POS shown in FIG. 12.

### DETAILED DESCRIPTION

In accordance with a first embodiment, an information processing apparatus includes an acquisition module configured to acquire the image captured by an image capturing module having sensitivity to visible light and near-infrared ray, a first extraction module configured to extract a first feature amount of the captured commodity from an infrared ray image representing the near-infrared ray component of the captured image, a second extraction module configured to extract a second feature amount of the captured commodity from a visible light image representing the visible light component of the captured image and a recognition module configured to recognize the commodity based on at least one of the first feature amount and the second feature amount.

Embodiments of the information processing apparatus and method are described in detail below with reference to accompanying drawings. In addition, the embodiments described below are embodiments of the information processing apparatus and method and are not presented to limit the configuration or specification of the information processing apparatus and method. The present embodiment is an application examples applied to a checkout system comprising a POS terminal for registering and settling the commodities involved in one transaction and a commodity reading apparatus for reading the information relating to a commodity which are imported in a store such as a supermarket.

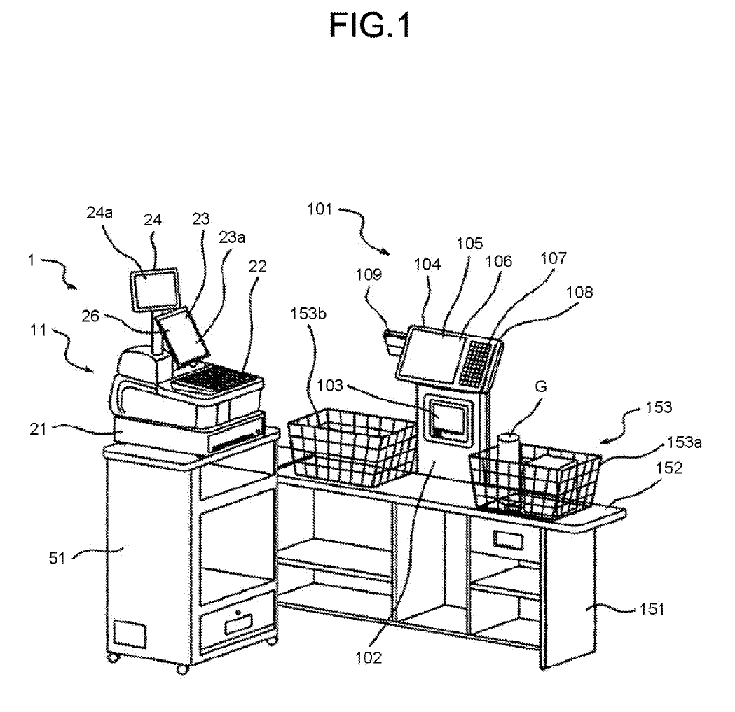

FIG. 1 is a perspective view illustrating external configuration of a checkout system 1. As shown in FIG. 1, the checkout system 1 comprises a POS terminal 11 and a commodity reading apparatus 101 serving as an information processing apparatus.

The POS terminal 11 is placed on the drawer 21 on a checkout counter 51. The drawer 21 is opened under the control of the POS terminal 11. A keyboard 22 is arranged on the upper surface of the POS terminal 11 for an operator (shop clerk) to operate. Seen from the operator operating the keyboard 22, a display device 23 for displaying information to the operator is arranged more rear than the keyboard 22. The display device 23 displays information on the display screen 23a thereof. A touch panel 26 is laminated on the display screen 23a. A display for customer 24 is vertically arranged to be capable of rotating freely at a position more rear than the display device 23. The display for customer 24 displays information on the display screen 24a thereof.

Moreover, the display screen 24a of the display for customer 24 is directed to the nearer side of the operator in FIG. 1, however, the display for customer 24 can be rotated such that the display screen 24a is directed to the rear side of FIG. 1, thereby displaying the information to a customer.

A horizontally long table-shaped counter table 151 is arranged to be in an L shape with the checkout counter 51 on which the POS terminal 11 is placed. A commodity receiving surface 152 is formed on the counter table 151. Shopping baskets 153 for storing commodities G are placed on the commodity receiving surface 152. It can be considered to classify the shopping baskets 153 into a first shopping basket 153a which is held by a customer and a second shopping basket 153b which is placed facing the first shopping basket 153a across a commodity reading apparatus 101.

The commodity reading apparatus 101, which is connected with the POS terminal 11 to be capable of carrying out data transmission/reception, is arranged on the commodity receiving surface 152 of the counter table 151. The commodity reading apparatus 101 has a thin rectangular housing 102.

A reading window 103 is arranged on the front side of the housing 102. A display and operation section 104 is arranged at the upper part of the housing 102. A display device 106 having a touch panel 105 laminated on the surface thereof is arranged on the display and operation section 104. A keyboard 107 is arranged on the right of the display device 106. A card reading slit 108 of a card reader (not shown) is arranged on the right of the keyboard 107. Seen from the side of an operator, a display for customer 109 is arranged at the left of the back side of the display and operation section 104 to provide information for a customer.

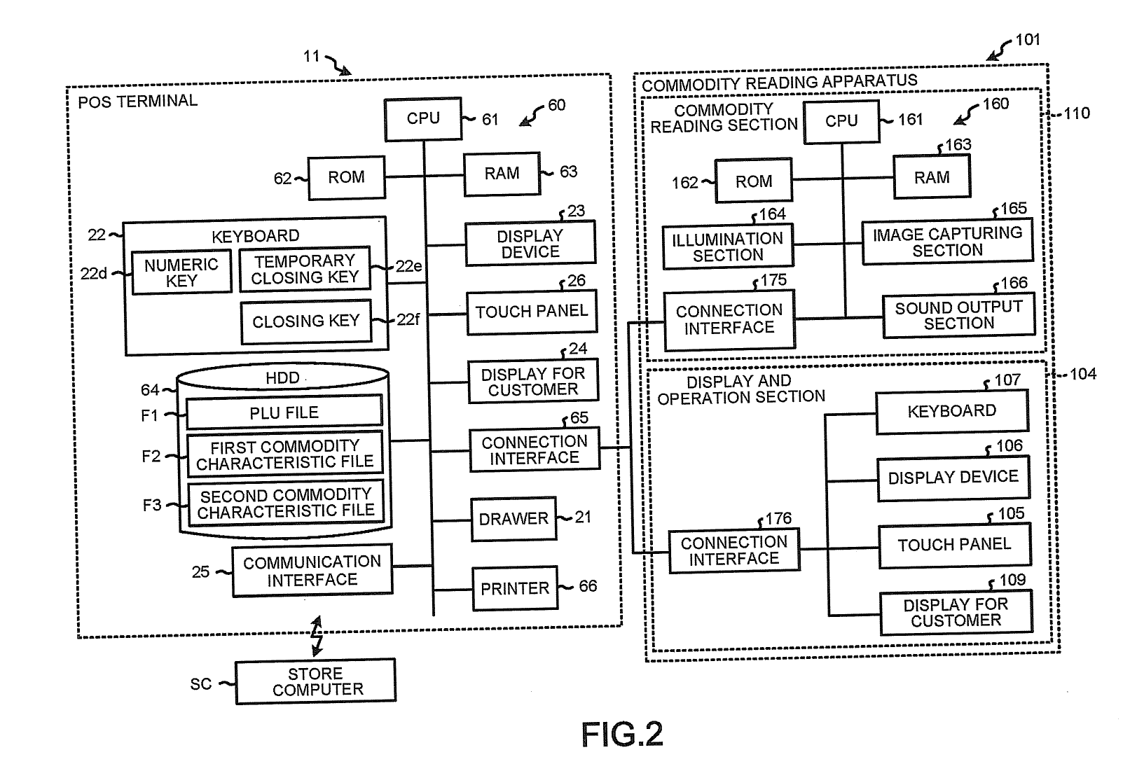

Such a commodity reading apparatus 101 comprises a commodity reading section 110 (referring to FIG. 2). In the commodity reading section 110, an image capturing section (referring to FIG. 2) is arranged behind the reading window 103.

The commodities G involved in one transaction are stored in the first shopping basket 153a held by a customer. The commodities G in the first shopping basket 153a are moved to the second shopping basket 153b by the operator operating the commodity reading apparatus 101. When being moved, the commodities G are directed to the reading window 103 of the commodity reading apparatus 101. At this time, the image capturing section 165 (referring to FIG. 2) arranged in the reading window 103 captures images of the commodities G.

FIG. 2 is a block diagram illustrating the hardware arrangement of the POS terminal 11 and the commodity reading apparatus 101.

The POS terminal 11 comprises a microcomputer 60 serving as an information processing section for executing information processing. The microcomputer 60 is configured by connecting a CPU (Central Processing Unit) 61 which executes various arithmetic operations and controls each section with a ROM (Read Only Memory) 62 and a RAM (Random Access Memory) 63 via a bus line.

The drawer 21, the keyboard 22, the display device 23, the touch panel 26 and the display for customer 24 are all connected with the CPU 61 of the POS terminal 11 via various input/output circuits (not shown).

The keyboard 22 includes a numeric key 22d on which numeric characters such as ‘1’, ‘2’, ‘3’ and operators such as multiplying operator ‘*’ are displayed, a temporary closing key 22e and a closing key 22f.

The CPU 61 of the POS terminal 11 is connected with an HDD (Hard Disk Drive) 64, in which various programs and files are stored. When the POS terminal 11 is started, the programs stored in the HDD 64 are all or partially copied into the RAM 63 and executed by the CPU 61.

Further, data files such as a PLU file F1, a first commodity characteristic file F2 and a second commodity characteristic file F3 and the like are stored in the HDD 64. Further, the PLU file F1, the first commodity characteristic file F2 and the second commodity characteristic file F3 are held by being able to be read (referred to) from the commodity reading apparatus 101 via a connection interface 65 which will be described later.

The PLU file F1 is a data file in which a commodity G sold in the store is set in association with information relating to the sales registration of the commodity G.

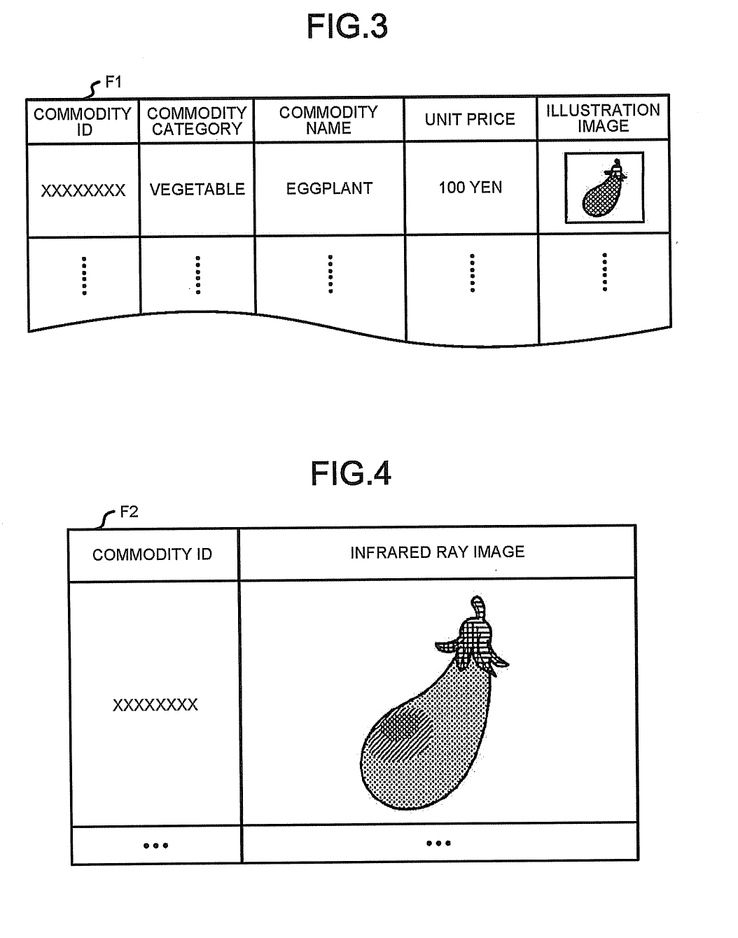

FIG. 3 is a diagram schematically illustrating an example of the data configuration of the PLU file F1. As shown in FIG. 3, a commodity ID uniquely allotted to each commodity G, information relating to a commodity such as a commodity category to which the commodity G belongs, a commodity name and a unit price, and an illustration image representing the commodity are registered as commodity information of the commodity G in the PLU file F1. Hereinafter, the commodity G in association with a commodity ID is referred to as a registration commodity.

Further, in the first commodity characteristic file F2, each commodity G sold in the store is stored in association with the information obtained by capturing the commodity G with near-infrared ray.

FIG. 4 is a diagram schematically illustrating an example of the data configuration of the first commodity characteristic file F2. As shown in FIG. 4, in the first commodity characteristic file F2, the commodity ID of each commodity G is registered in association with a captured image (infrared ray image) obtained by capturing the commodity G with near-infrared ray (e.g. 700 nm-2500 nm). Herein, the commodity ID is corresponding to a commodity ID registered in the PLU file F1. The data configuration of the first commodity characteristic file F2 is not limited to the example shown in FIG. 4, for example, it may be set that the feature amount such as the color, pattern, concave-convex situation, shape and the like of the commodity G read from the infrared ray image are registered instead of the infrared ray image.

Further, in the second commodity characteristic file F3, each commodity G sold in the store is stored in association with the information obtained by capturing the commodity G with visible lights (e.g. 400 nm-700 nm).

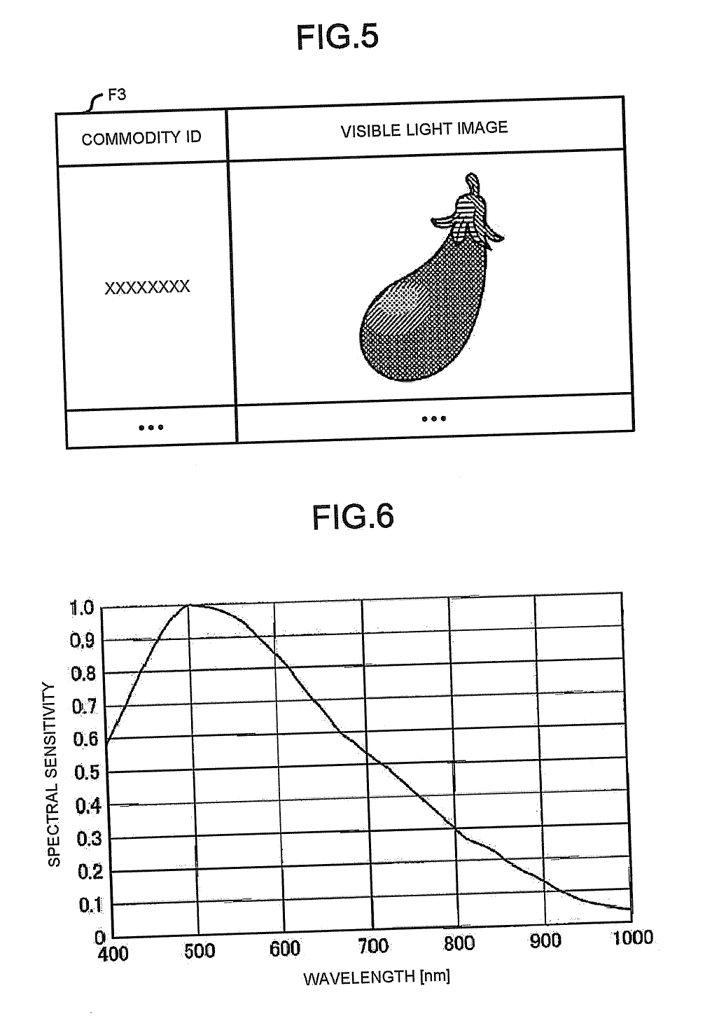

FIG. 5 is a diagram schematically illustrating an example of the data configuration of the second commodity characteristic file F3. As shown in FIG. 5, in the second commodity characteristic file F3, the commodity ID of each commodity G is registered in association with a captured image (visible light image) obtained by capturing the commodity G with visible lights. Herein, the commodity ID is corresponding to the commodity ID registered in the PLU file F1. The data configuration of the second commodity characteristic file F3 is not limited to the example shown in FIG. 5, for example, it may be set that the feature amount such as the color, pattern, concave-convex situation, shape and the like of the commodity G read from the visible light image are registered instead of the visible light image.

Further, the infrared ray image and the visible light image are registered in files different from the PLU file F1 in the example above, however, the present invention is not limited to this, the infrared ray image and the visible light image may be registered in the PLU file F1 in association with a corresponding commodity ID.

Return to FIG. 2, a communication interface 25 for executing data communication with a store computer SC is connected with the CPU 61 of the POS terminal 11 via an input/output circuit (not shown). The store computer SC is arranged in the backyard and the like of a store. The PLU file F1 and the first commodity characteristic file F2 distributed to the POS terminal 11 are stored in the HDD (not shown) of the store computer SC.

Further, the connection interface 65 capable of carrying out data transmission/reception with the commodity reading apparatus 101 is connected with the CPU 61 of the POS terminal 11. The commodity reading apparatus 101 is connected with the connection interface 65. Further, a printer 66 for printing on a receipt is connected with the CPU 61 of the POS terminal 11. The printer 66 prints the content of a transaction on a receipt under the control of the CPU 61.

Further, as shown in FIG. 2, the commodity reading apparatus 101 comprises a microcomputer 160. The microcomputer 160 is configured by connecting a CPU 161 with a ROM 162 which stores programs executed by the CPU 161 and a RAM 163 via the bus line.

An illumination section(module) 164, the image capturing section(module) 165 and a sound output section(module) 166 are connected with the CPU 161 via various input/output circuits (not shown). Actions of the illumination section 164, the image capturing section 165 and the sound output section 166 are controlled by the CPU 161.

The illumination section 164 is an illumination apparatus arranged in the reading window 103 to irradiate illumination light to the image capturing area of the image capturing section 165. The illumination section 164 irradiates light containing visible lights and infrared (near-infrared ray) components as illumination light. Herein, no limitation is given to the number of the illumination sections 164, one illumination section 164 may be set to illuminate, or dedicated illumination sections 164 may be set to respectively irradiate visible lights and infrared. Further, in the case where dedicated illumination sections 164 are set, the illumination sections 164 may be turned on synchronously or not synchronously.

The image capturing section 165 is a color CCD sensor or color CMOS and the like which carries out image capturing from the reading window 103 under the control of the CPU 161. For example, dynamic images are captured by the image capturing section 165 at 30 fps. The frame images (captured images) sequentially captured by the image capturing section 165 at a given frame rate are stored in the RAM 163.

In addition, image sensors using a color CCD and a color CMOS sensor, although different in image capturing area from each other due to the difference in material, are sensitive enough to capture a near-infrared ray area as well as a visible light area. As near-infrared ray component invisible to human are not needed in relating image sensors, an IR cut filter for removing near-infrared ray component is usually added, and the relating image sensors carrying out image capturing with near-infrared ray component removed.

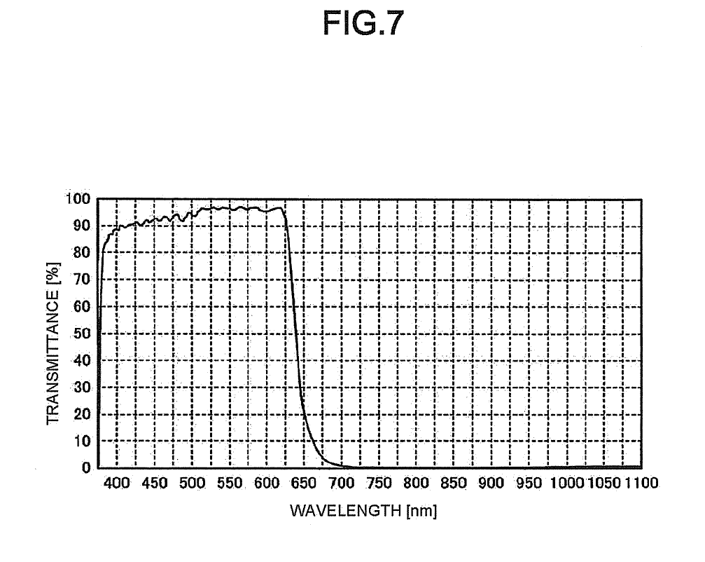

For example, in the case where the spectral sensitivity characteristic of an image sensor is represented with the graph shown in FIG. 6, the IR cut filter having a transmission characteristic shown in FIG. 7, if added, removes a near-infrared ray area (area of above 700 nm). Herein, FIG. 6 is a diagram illustrating an example of the spectral sensitivity characteristic of an image sensor, in which the ordinate represents spectral sensitivity and the abscissa represents wavelength (nm). Further, FIG. 7 is a diagram illustrating an example of the transmission characteristic of an IR cut filter, in which the ordinate represents transmittance (%) and the abscissa represents wavelength (nm)

On the other hand, the image sensor of the image capturing section 165 used in the present embodiment provided with no IR cut filter is capable of acquiring a captured image containing near-infrared ray component in addition to visible lights. Herein, the information obtained from the near-infrared ray (reflected light) of the object has characteristics different from that of the information obtained from visible lights.

Specifically, since near-infrared ray is little scattered and highly transmitted, a captured image of transmission state of the thin material such as a bag or a net for packaging such as a vinyl bag added to the commodity can be obtained. Further, since it is different for a dye or pigment to absorb near-infrared ray, for example, a captured image by which a nearly black object such as an eggplant blocked by the image capturing section 165 can be recognized can be obtained even if the background is almost black.

Return to FIG. 2, the sound output section 166 includes a sound circuit and a speaker for generating a preset alarm sound and the like. Under the control of the CPU 161, the sound output section 166 notifies by a sound such as an alarm sound and the like.

Further, the connection interface 175 which is connected with the connection interface 65 of the POS terminal 11 to be capable of carrying out data transmission/reception with the POS terminal 11 is connected with the CPU 161. Further, the display and operation section 104 is connected with the connection interface 175 via a connection interface 176, and the CPU 161 carries out data transmission/reception with the display and operation section 104 via the connection interface 175.

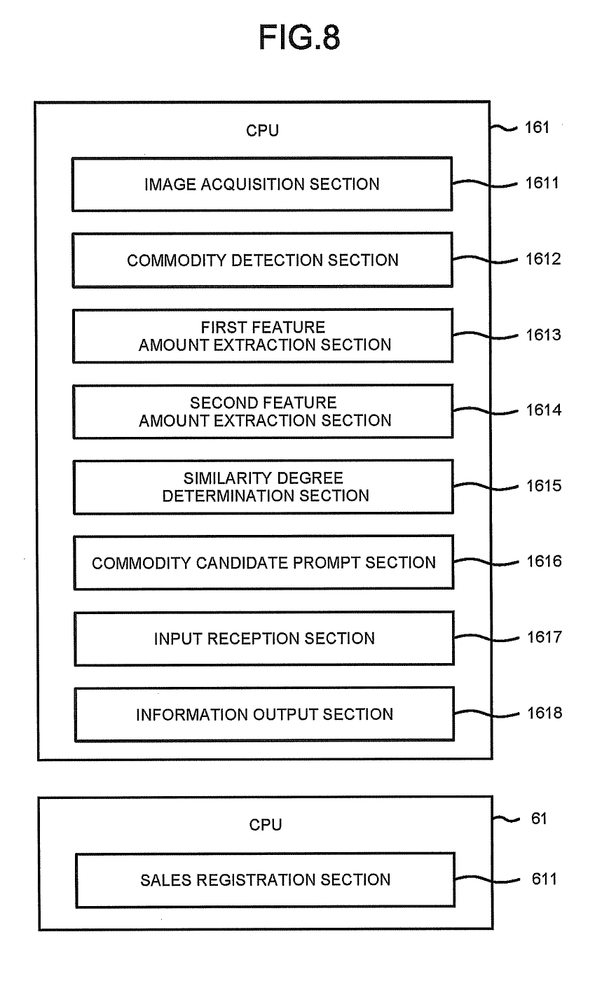

Next, the functional components of the CPU 161 and the CPU 61 realized by executing programs are described below with reference to FIG. 8.

FIG. 8 is a block diagram illustrating the functional components of the POS terminal 11 and the commodity reading apparatus 101. As shown in FIG. 8, by executing programs sequentially, the CPU 161 of the commodity reading apparatus 101 functions as an image acquisition section(module) 1611, a commodity detection section(module) 1612, a first feature amount extraction section (module) 1613, a second feature amount extraction section(module) 1614, a similarity degree determination section(module) 1615, a commodity candidate prompt section(module) 1616, an input reception section (module) 1617 and an information output section (module) 1618.

The image acquisition section 1611 outputs an ON-signal of image capturing to the image capturing section 165 to activate the image capturing section 165 to start an image capturing action. The image acquisition section 1611 sequentially acquires the captured images which are captured by the image capturing section 165 and stored in the RAM 163 after the image capturing action is started. The image acquisition section 1611 acquires the captured images in accordance with the storage order of the images in the RAM 163.

The commodity detection section 1612 detects all or part of the outline of the commodity G contained in the captured image acquired by the image acquisition section 1611 using a known pattern matching technology. Next, the outline extracted from the former captured image (frame image) is compared with that extracted from the current frame image to detect a changed part, that is, the reflection of a commodity G facing the reading window 103.

Further, as another commodity detection method, it is determined whether or not a flesh color area is detected from the captured image, if the flesh color area is detected, that is, the reflection of the hand of a shop clerk is detected, the detection of the aforementioned outline nearby the flesh color area is carried out to try to extract the outline of a commodity assumed to be held by the shop clerk. At this time, if an outline representing the shape of a hand and the outline of another object nearby the hand outline are detected, a commodity is detected from the outline of the object.

The first feature amount extraction section 1613 reads, from an image representing the near-infrared ray component (hereinafter referred to as infrared ray image) of the captured image acquired by the image acquisition section 1611, the surface state (surface color, pattern, concave-convex situation, shape and the like) of the commodity detected by the commodity detection section 1612 as first feature amount.

The second feature amount extraction section 1614 reads, from an image representing the visible light component (hereinafter referred to as visible light image) of the captured image acquired by the image acquisition section 1611, the surface state (surface color, pattern, concave-convex situation, shape and the like) of the commodity detected by the commodity detection section 1612 as second feature amount.

The similarity degree determination section 1615 compares the first feature amount extracted by the first feature amount extraction section 1613 with the feature amount of each registration commodity (infrared ray image) registered in the first commodity characteristic file F2 of the POS terminal 11 and specifies the registration commodity (commodity ID) of which the similarity degree between the two feature amounts is above a specified threshold value from the first commodity characteristic file F2. Herein, the similarity degree is any value (similarity degree) representing how much similar are the two feature amounts by comparing the first feature amount with the feature amount of the each registration commodity registered in the first commodity characteristic file F2. Further, the concept of the similarity degree is not limited to the example above, the similarity degree may also be a value representing the degree of coincidence of the first feature amount with the feature amount of each registration commodity registered in the first commodity characteristic file F2, or a value representing the degree of correlation between the first feature amount and the feature amount of each registration commodity registered in the first commodity characteristic file F2.

Specifically, the similarity degree determination section 1615 calculates the similarity degree between the commodity contained in an infrared ray image and each registration commodity registered in the first commodity characteristic file F2 by comparing the feature amounts and recognizes the registration commodity (commodity ID) of which the similarity degree between the two feature amounts is above a specified threshold value as a candidate of the commodity G captured by the image capturing section 165.

Further, the similarity degree determination section 1615 compares the second feature amount extracted by the second feature amount extraction section 1614 with the feature amount of each registration commodity (visible light image) registered in the second commodity characteristic file F3 of the POS terminal 11 and specifies the commodity (commodity ID) of which the similarity degree representing the relationship between the two feature amounts is above a specified threshold value from the second commodity characteristic file F3. Herein, the similarity degree is any value (similarity degree) representing how much similar are the two feature amounts by comparing the second feature amount with the feature amount of each registration commodity registered in the second commodity characteristic file F3. Further, the concept of the similarity degree is not limited to the example above, the similarity degree may also be a value representing the degree of coincidence of the second feature amount with the feature amount of each registration commodity registered in the second commodity characteristic file F3, or a value representing the degree of correlation between the second feature amount and the feature amount of each registration commodity registered in the second commodity characteristic file F3.

Specifically, the similarity degree determination section 1615 respectively calculates the similarity degree between the commodity contained in a visible light image and each registration commodity registered in the second commodity characteristic file F3 by comparing the feature amounts and recognizes the registration commodity (commodity ID) of which the similarity degree between the two feature amounts is above a specified threshold value as a candidate of the commodity G contained in the visible light image.

The recognition of an object contained in an image stated above is referred to as generic object recognition. As to the generic object recognition, various recognition technologies are described in the following document.

Keiji Yanai “The current state and future directions on generic object recognition”, Journal of Information Processing Society, Vol. 48, No. SIG16 [Search on Heisei 24 July 26], Internet <URL: http://mm.cs.uec.ac.jp/IPSJ-TCVIM-Yanai pdf>

In addition, the technology carrying out the generic object recognition by performing an area-division on the image for each object is described in the following document.

Jamie Shotton etc, “Semantic Texton Forests for Image Categorization and Segmentation”, [Search on Heisei 24 July 26], Internet <URL: http://citeseerx.ist.psu.edu/viewdoc/download?doi=10.1.1.14 5.3036&rep=repl&type=pdf>

In addition, no limitation is given to the method for calculating the similarity degree between the image of a captured commodity G and commodity images of the registration commodities registered in the first commodity characteristic file F2 and the second commodity characteristic file F3. For example, the similarity degree between the image of the captured commodity G and registration commodities can be calculated as an absolute evaluation or a relative evaluation.

If the similarity degree is calculated as an absolute evaluation, the similarity degree is the directly-exported comparison result of a comparison between the image of the captured commodity G and each of the registration commodities. In addition, if the similarity degree is calculated as a relative evaluation, the similarity degree can be calculated as long as the sum of the similarity degrees between the captured commodity G and each registration commodities is 1.0 (100%).

The commodity candidate prompt section 1616 displays information relating to the registration commodity recognized by the similarity degree determination section 1615 as a candidate on the display device 106 as a commodity candidate. Specifically, the commodity candidate prompt section 1616 reads commodity information of the registration commodities recognized as candidates from the PLU file F1 of the POS terminal 11, and displays on the display device 106 in the descending order of similarity degree.

Further, although the method for prompting a commodity candidate using the result of a recognition processing based on an infrared ray image and a visible light image is described in the present embodiment, no specific limitation is given to the method for selecting a commodity candidate. For example, the registration commodities recognized from extraction results of the first and second feature amount extraction sections 1613 and 1614 may be all prompted, or only the registration commodities having the same commodity ID are prompted. Further, a commodity candidate may be prompted using the extraction result of either of the first feature amount extraction section 1613 and the second feature amount extraction section 1614.

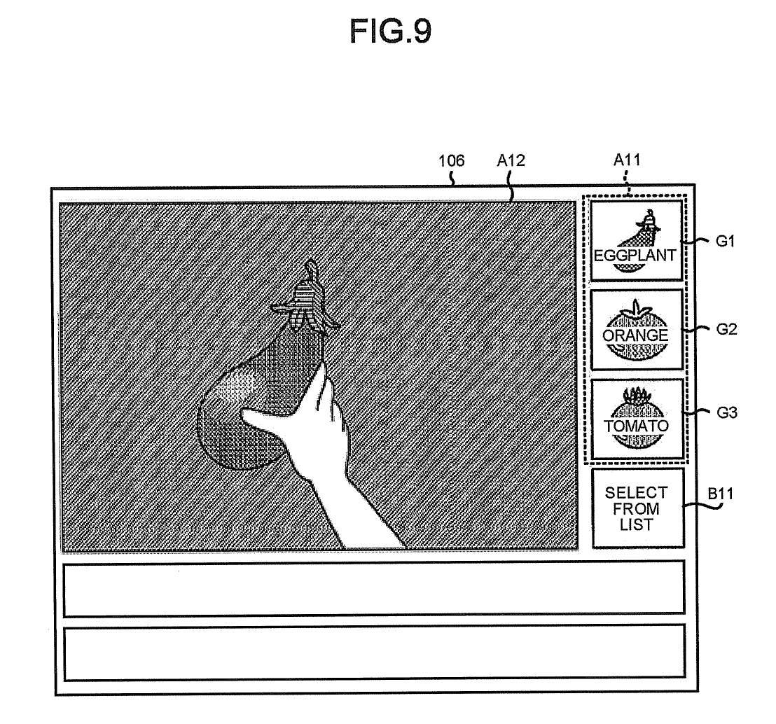

FIG. 9 is a diagram illustrating a display example of commodity candidates. As shown in FIG. 9, in a commodity candidate prompt area A11 on the display screen of the display device 106, the illustration images G1, G2 and G3 contained in the commodity information of commodity candidate are displayed in the descending order of similarity degree of the registration commodity together with the commodity names. The illustration images G1, G2 and G3 can be selected by touching the touch panel 105. Further, a selection button B11 is arranged in the lower part of the commodity candidate prompt area A11 to select a commodity from a commodity list, and the commodity selected from the commodity list is processed as a determined commodity which will be described later. Further, the captured image acquired by the image acquisition section 1611 is displayed in the area A12.

Further, three commodity candidates are exemplarily prompted in FIG. 9, however, the method for prompting commodity candidates is not limited to this. For example, a visible light image registered in the second commodity characteristic file F3 may be displayed instead of the illustration images.

Return to FIG. 8, the input reception section 1617 receives various input operations corresponding to the display of the display device 106 through the touch panel 105 or keyboard 107. For example, the input reception section 1617 receives a selection operation of selecting any one commodity candidate from the illustration images (referring to FIG. 9) of the commodity candidates displayed on the display device 106. The input reception section 1617 receives the commodity candidate of the selected illustration image as a commodity (determined commodity) corresponding to the commodity G captured by the image capturing section 165. Further, if a plurality of commodities G are detected by the commodity detection section 1612, the input reception section 1617 may receive a selection operation of selecting a plurality of candidates from commodity candidates.

The information output section 1618 outputs information (e.g. commodity ID or commodity name) representing a determined commodity determined in the way stated above to the POS terminal 11 via the connection interface 175.

Further, the information output section 1618 may output the sales volume input from the touch panel 105 or keyboard 107 in another way together with commodity ID to the POS terminal 11. Further, as information output to the POS terminal 11 by the information output section 1618, the commodity ID read by the information output section 1618 from the PLU file F1 may be directly notified, or a commodity name, a commodity image (infrared ray image or visible light image) and the file name of an illustration image capable of specifying a commodity ID may be notified, or a storage position (a storage address in the PLU file F1) of the commodity ID may be notified.

On the other hand, by executing a program, the CPU 61 of the POS terminal 11 can function as a sales registration section (module) 611, which registers the sales of a corresponding commodity based on the commodity ID and sales volume output from the information output section 1618 of the commodity reading apparatus 101. Specifically, the sales registration section 611 carries out a sales registration by recording the notified commodity ID and the commodity category, commodity name, unit price corresponding to the commodity ID in a sales master file together with sales volume with reference to the PLU file F1.

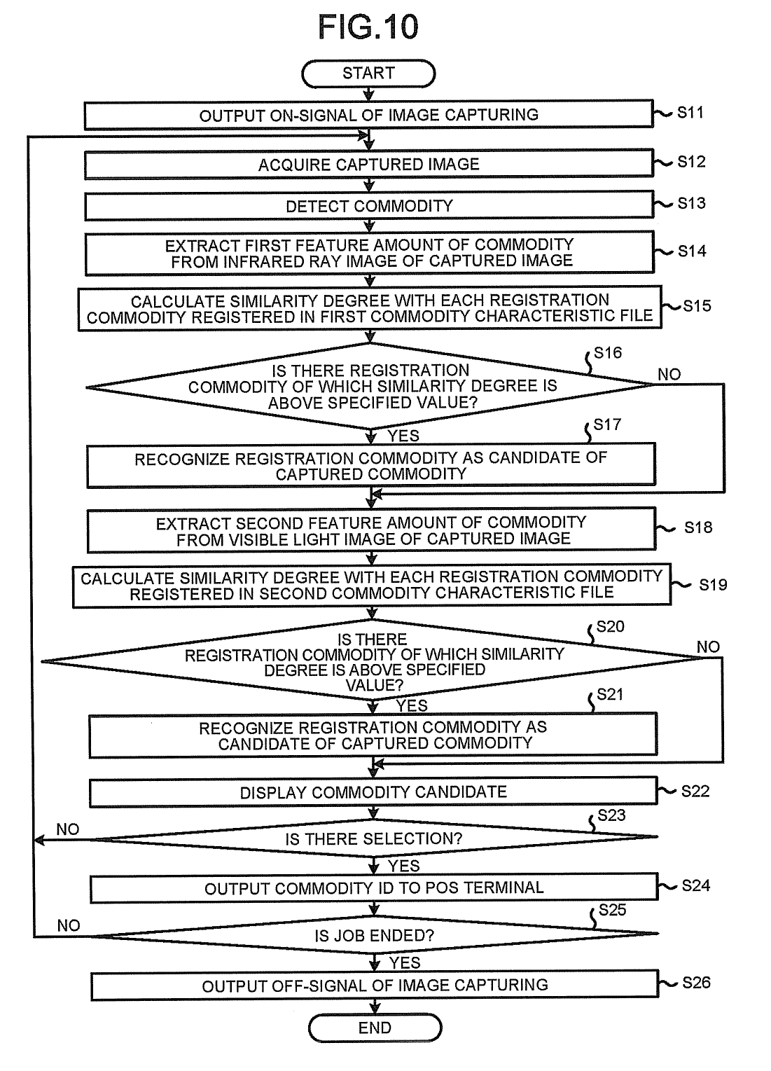

Next, actions of the checkout system 1 are described. Actions of the commodity reading apparatus 101 are described first. FIG. 10 is a flowchart illustrating the procedure of a commodity recognition processing executed by the commodity reading apparatus 101.

As shown in FIG. 10, when a processing is started in response to the start of the commodity registration by the POS terminal 11, the image acquisition section 1611 outputs an ON-signal of image capturing to the image capturing section 165 to activate the image capturing section 165 to start an image capturing action (ACT S11).

The image acquisition section 1611 acquires the frame images (captured images) that are captured by the image capturing section 165 and then stored in the RAM 163 (ACT S12). Next, the commodity detection section 1612 detects all or part of the commodity G from the captured image acquired in ACT S12 (ACT S13).

The first feature amount extraction section 1613 extracts the first feature amount of the commodity G detected in ACT S13 from the infrared ray image of the captured image acquired in ACT S12 (ACT S14).

The similarity degree determination section 1615 calculates the similarity degree between the first feature amount extracted in ACT S14 and the feature amount of each registration commodity (infrared ray image) registered in the first commodity characteristic file F2 of the POS terminal 11 (ACT S15). Sequentially, the similarity degree determination section 1615 determines whether or not the registration commodities the similarity degrees are calculated in ACT S15 include a registration commodity of which the similarity degree with the first feature amount extracted in ACT S14 is above a specified threshold value (ACT S16).

If it is determined that the registration commodity of which the similarity degree is above a specified threshold value exists (YES in ACT S16), the first feature amount extraction section 1613 recognizes the registration, commodity as a candidate of the commodity G captured by the image capturing section 165 (ACT S17), and then ACT S18 is executed. Further, if it is determined that the registration commodity of which the similarity degree is above a specified threshold value doesn't exist (NO in ACT S16), the flow proceeds to ACT S18 directly.

The second feature amount extraction section 1614 extracts the second feature amount of the commodity G detected in ACT S13 from the visible light image of the captured image acquired in ACT S12 (ACT S18).

The similarity degree determination section 1615 calculates the similarity degree between the second feature amount extracted in ACT S18 and the feature amount of each registration commodity (visible light image) registered in the second commodity characteristic file F3 of the POS terminal 11 (ACT S19). Sequentially, the similarity degree determination section 1615 determines whether or not the registration commodities of which the similarity degrees are calculated in ACT S19 include a registration commodity of which the similarity degree with the second feature amount extracted in ACT S18 is above a specified threshold value (ACT S20).

If it is determined that the registration commodity of which the similarity degree is above a specified threshold value exists in ACT S20 (YES in ACT S20), the second feature amount extraction section 1614 recognizes the registration commodity as a candidate of the commodity G captured by the image capturing section 165 (ACT S21), and then ACT S22 is executed. Further, if it is determined that the registration commodity of which the similarity degree is above a specified threshold value doesn't exist (NO in ACT S20), the flow proceeds to ACT S22 directly.

Further, the registration commodity subjected to a similarity degree calculation may be limited in ACT S19. For example, the registration commodity which is recognized in ACT S17 as a candidate of the commodity G from the registration commodities registered in the second commodity characteristic file F3 may be taken as the object subjected to a similarity degree calculation, or a registration commodity excluding the registration commodity which is recognized in ACT S17 as a candidate of the commodity G may be taken as the object subjected to a similarity degree calculation.

Next, in ACT S22, the commodity candidate prompt section 1616 displays information relating to the registration commodity recognized in ACT S17 and ACT S21 as a candidate on the display device 106 as a commodity candidate (ACT S22). Further, if there is no commodity candidate, then the content ‘no similar registration commodity’ is displayed on the display device 106 so that the customer is prompted to make a selection from the commodity list.

The input reception section 1617 determines whether or not a selection on a commodity candidate is received through the touch panel 105 or keyboard 107 (ACT S23). Herein, if the selection on a commodity candidate is received (YES in ACT S23), the input reception section 1617 receives the selected commodity candidate as a determined commodity corresponding to the commodity G captured by the image capturing section 165, then, the flow proceeds to ACT S24. On the other hand, if no selection is received (NO in ACT S23), the flow returns to ACT S12 again.

Sequentially, the information output section 1618 outputs information such as a commodity ID and the like representing the determined commodity selected in ACT S23 to the POS terminal 11 via the connection interface 175 (ACT S24), and then the flow proceeds to ACT S25.

Herein, if a sales volume is input through the touch panel 105 or the keyboard 107 in another way, the sales volume of the determined commodity is also output to the POS terminal 11 together with the information representing the determined commodity in ACT S25. In addition, if no sales volume is input, a sales volume ‘1’ may be output as a default value.

In ACT S25, the CPU 161 determines whether or not a job is ended based on a commodity registration ending notice sent from the POS terminal 11 (ACT S25). Herein, if the job is to be continued (NO in ACT S25), the CPU 161 returns to ACT S12 to continue the processing. On the other hand, if the job is ended (YES in ACT S25), the image acquisition section 1611 outputs an OFF-signal of image capturing to the image capturing section 165 to end the image capturing of the image capturing section 165 (ACT S26), then the processing is ended.

Further, ACTs S18-S21 are executed after ACTs S14-S17 in the processing above, however, the present invention is not limited to this, ACTs S14-S17 may be executed after or in synchronization with ACTs S18-S21.

Further, any processing of ACTs S14-S17 or ACTs S18-S21 is executed if a commodity candidate is prompted using the extraction result of either of the first and second feature amount extraction sections 1613 and 1614.

For example, if a candidate of the commodity G is recognized in ACTs S14-S17, then ACT S22 is executed without executing ACTs S18-S21, which quickens the processing speed. Further, if the recognition on a candidate of the commodity G in ACTs S14-S17 is failed, then a commodity which cannot be recognized in ACTs S14-S17 can be recognized by executing ACTs S18-S21. Further, when ACTs S18-S21 are executed after ACTs S14-S17, if a candidate of the commodity G is recognized in ACTs S18-S21, then ACT S22 is executed without executing ACTs S14-S17, if the recognition on a candidate of the commodity G is failed in ACTs S18-S21, then ACTs S14-S17 are executed. Herein, ‘failure in candidate recognition’ refers to, for example, that the candidate of the commodity of which the similarity degree is above the specified threshold value is not able to be uniquely specified or none of the candidate of a commodity of which the similarity degree is above the specified threshold value is extracted.

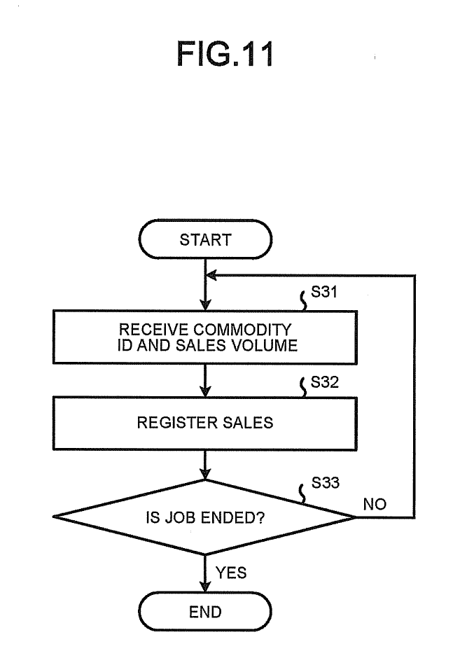

Next, processing actions of the POS terminal 11 are described. FIG. 11 is a flowchart illustrating the procedure of a sales registration processing executed by the POS terminal 11.

First, when the processing is started in responses to the start of the commodity registration according to an operation indication from the keyboard 22, the CPU 61 receives the commodity ID of a determined commodity output by the commodity reading apparatus 101 in ACT S24 of FIG. 10 and the sales volume of the determined commodity (ACT S31). Next, the sales registration section 611 reads a commodity category or unit price and the like from the PLU file F1 based on the commodity ID and sales volume received in ACT S31 and registers the sales of the commodity G read by the commodity reading apparatus 101 in a sales master file (ACT S32).

Sequentially, the CPU 61 determines whether or not a job is ended based on the ending of the sales registration according to the operation indication of the keyboard 22 (ACT S33). If the job is to be continued (NO in ACT S33), the CPU 61 returns to ACT S31 to continue the processing. If the job is ended (YES in ACT S33), the CPU 61 ends the processing.

As stated above, in accordance with the present embodiment, the feature amount (first feature amount and second feature amount) of the commodity G is extracted from each of the infrared ray image and visible light image captured by the image capturing section 165, and a registration commodity is recognized from the first and second commodity characteristic files F2 and F3 based on the feature amount as a candidate of the commodity G. Thus, even in the case where it is difficult to extract feature amount (second feature amount) with visible light since the background and the commodity are of similar colors, the feature amount (first feature amount) of the commodity G can be extracted from an infrared ray image, thus, the recognition rate of the commodity G can be increased by using the feature amount.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

Further, it is assumed in the embodiment above that a PLU file F1, a first commodity characteristic file F2 and a second commodity characteristic file F3 are included in the POS terminal 11, however, the present invention is not limited to this, all or part of the PLU file F1, the first commodity characteristic file F2 and the second commodity characteristic file F3 may be included in the commodity reading apparatus 101.

Further, it is set in the embodiment above that a commodity candidate is recognized in the commodity reading apparatus 101, however, all or part of the functional sections of the commodity reading apparatus 101 may be included by the POS terminal 11. For example, the POS terminal 11 may comprise a commodity detection section 1612, a first feature amount extraction section 1613, a second feature amount extraction section 1614 and a similarity degree determination section 1615, and the commodity reading apparatus 101 may comprise an image acquisition section 1611, a commodity candidate prompt section 1616, an input reception section 1617 and an information output section 1618. In this case, it may be set that the captured image acquired by the image acquisition section 1611 may be sent to the POS terminal 11 at the side of the commodity reading apparatus 101, a result of a recognized commodity (registration commodity) is received at the side of the POS terminal 11, and the commodity candidate prompt section 1616 prompts the received result as a commodity candidate. Further, if the functional sections of the commodity reading apparatus 101 are all included by the POS terminal 11, the commodity reading apparatus 101 functions as an image capturing apparatus, and a commodity candidate is displayed and selected in the POS terminal 11 based on the captured image sent from the commodity reading apparatus 101.

Further, the aforementioned embodiment is applied to the commodity reading apparatus 101 of the checkout system 1 including the POS terminal 11 and the commodity reading apparatus 101, however, the present invention is not limited to this, embodiments of the present invention may also be applied to an apparatus comprising the functions of the POS terminal 11 and the commodity reading apparatus 101 or a checkout system formed by, for example, connecting the commodity reading apparatus 101 with the POS terminal 11 shown in FIG. 1 in a wired or wireless manner. A self-checkout apparatus (hereinafter referred to as a self POS for short) arranged and used in a store such as a supermarket can be listed as an apparatus comprising the functions of the POS terminal 11 and the commodity reading apparatus 101.

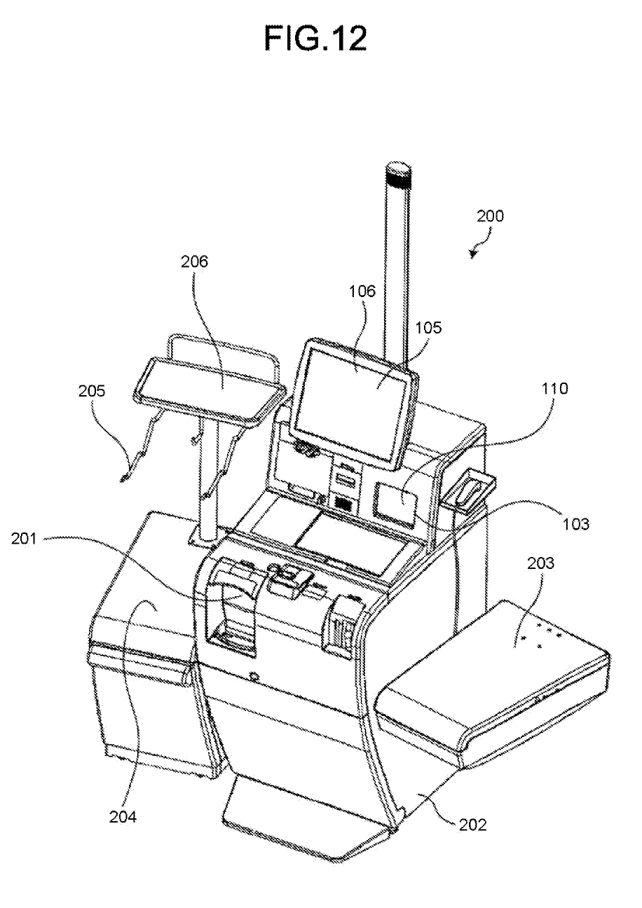

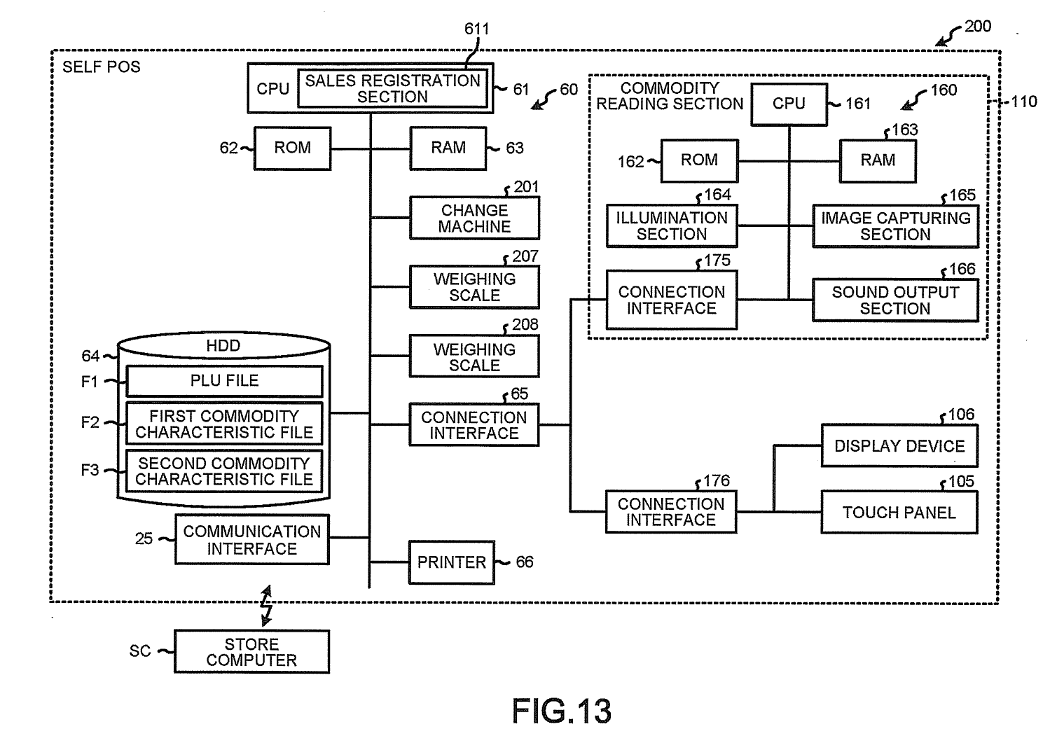

Herein, FIG. 12 is a perspective view illustrating the external configurations of a self POS 200, and FIG. 13 is a block diagram illustrating the hardware arrangement of the self POS 200. Further, the same configurations shown in FIG. 1 and FIG. 2 are denoted with the same signs and are therefore not described repeatedly.

As shown in FIG. 12 and FIG. 13, the main body 202 of the self POS 200 comprises a display device 106 having a touch panel 105 on the surface thereof and a commodity reading section 110 which reads a commodity image to recognize (detect) the category of a commodity.

The display device 106 may be, for example, a liquid crystal display. A guidance screen for providing the customer a guidance for the operation of the self POS 200, various input screens, a registration screen for displaying the commodity information read by the commodity reading section 110 and a settlement screen on which a total amount, a prepayment amount and a change amount as well as a payment method selection are displayed on the display device 106.

The commodity reading section 110 is a section which reads a commodity image using the image capturing section 165 when the customer holds the code symbol attached to a commodity over the reading window 103 of the commodity reading section 110.

Further, a commodity placing table 203 for placing the commodity in a shopping basket to be settled is arranged on the right side of the main body 202, and on the left side of the main body 202, a commodity placing table 204 for placing the settled commodity, a bag hook 205 for hooking a bag for placing the settled commodities and a temporary placing table 206 for placing the settled commodities temporarily before the settled commodities are placed into a bag are arranged. The commodity placing tables 203 and 204 are provided with weighing scales 207 and 208 respectively, and are therefore capable of confirming whether or not the weight of commodities is the same before and after a settlement.

Further, a change machine 201 for inputting bill for settlement and outputting bill as change is arranged in the main body 202 of the self POS 200.

In the case where the self POS 200 having such configurations is applied to embodiments of the present invention, the self POS 200 functions as an information processing apparatus. Further, the apparatus comprising the functions of the POS terminal 11 and the commodity reading apparatus 101 may be an apparatus provided with no weighing scales 207 and 208, but not limited to the self POS 200 having the configurations above.

Further, in the embodiment above, the programs executed by each apparatus are pre-incorporated in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via an LAN or the Internet.

In addition, the programs executed by each apparatus described in the embodiments above may be stored in a computer connected with a network such as the Internet to be provided through a network download or provided or distributed via a network such as the Internet.

Alternatively, the programs mentioned in the embodiments above may be incorporated in a portable information terminal such as a mobile phone having a communication function, a smart phone, a PDA (Person Digital Assistant) and the like to realize the functions of the programs.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
an acquisition module configured to acquire the image captured by an image capturing module having sensitivity to visible light and near-infrared ray;
a first extraction module configured to extract a first feature amount of the captured commodity from an infrared ray image representing the near-infrared ray component of the captured image;
a second extraction module configured to extract a second feature amount of the captured commodity from a visible light image representing the visible light component of the captured image; and
a recognition module configured to recognize the commodity based on at least one of the first feature amount and the second feature amount.

2. The information processing apparatus according to claim 1, wherein
the recognition module compares the first feature amount with the feature amount of each reference commodity captured with the near-infrared ray and recognizes the reference commodity of which a value representing the relationship between the two feature amounts is above a specified value as a candidate of the commodity.

3. The information processing apparatus according to claim 1, wherein
the recognition module compares the second feature amount with the feature amount of each reference commodity captured with the visible lights and recognizes the reference commodity of which a value representing the relationship between the two feature amounts is above a specified value as a candidate of the commodity.

4. The information processing apparatus according to claim 2, further comprising:
a prompt module configured to selectively prompt information relating to the candidate of the commodity, wherein
the recognition module determines the reference commodity corresponding to the selected commodity candidate to be the commodity.

5. The information processing apparatus according to claim 1, wherein
the recognition module recognizes the commodity using the other feature amount if the recognition module fails to recognize the commodity using one of the first feature amount and the second feature amount.

6. An information processing method, comprising:
acquiring the image captured by an image capturing module having sensitivity to visible light and near-infrared ray;
extracting a first feature amount of the captured commodity from an infrared ray image representing the near-infrared ray component of the captured image;
extracting a second feature amount of the captured commodity from a visible light image representing the visible light component of the captured image; and
recognizing the commodity based on at least one of the first feature amount and the second feature amount.

7. The information processing method according to claim 6, wherein
comparing the first feature amount with the feature amount of each reference commodity captured with the near-infrared ray and recognizes the reference commodity of which a value representing the relationship between the two feature amounts is above a specified value as a candidate of the commodity.

8. The information processing method according to claim 6, wherein
comparing the second feature amount with the feature amount of each reference commodity captured with the visible lights and recognizes the reference commodity of which a value representing the relationship between the two feature amounts is above a specified value as a candidate of the commodity.

9. The information processing method according to claim 7, further comprising:
prompting information relating to the candidate of the commodity selectively, wherein
determining the reference commodity corresponding to the selected commodity candidate to be the commodity.

10. The information processing method according to claim 6, wherein
recognizing the commodity using the other feature amount if recognition of the commodity using one of the first feature amount and the second feature amount fails.
